(19) United States
(12) Patent Application Publication
(10) Pub. No.: US 2012/0041808 A1
(43) Pub. Date: Feb. 16, 2012

(54) Mobile System and Method for Loyalty Currency Redemption

(75) Inventors: Dominic Hofer, Erlenbach/Zurich (CH); Luca Paioni, Magliaso (CH)

(73) Assignee: Loylogic Licensing Inc., Zurich (CH)

(21) Appl. No.: 12/855,933

(22) Filed: Aug. 13, 2010

(51) Int. Cl. G06Q 30/00

(52) U.S. Cl. 705/14.17; 705/14.23

(57) ABSTRACT

Systems and methods are disclosed for generating monetary currency using a mobile communications device for immediate use for the purchase of items, wherein the monetary currency comprises a credit instrument or a credit associated with a credit or debit card, the credit is valid for a defined period of time, and the credit is generated from converting non-monetary reward currency into monetary currency. The system and method are implemented by accessing a currency software module operating on the mobile communications device, which facilitates account log-in, entry of an item purchase amount and user selection of a loyalty program from which non-monetary currency can be redeemed and converted to monetary currency. The mobile communications device receives the credit from a payment provider server, typically via a currency server.

### RELATED APPLICATIONS

The present application incorporates herein by reference the entire content of the following related applications: U.S. patent application Ser. No. 12/729,746, filed Mar. 23, 2010, and entitled “Methods and Systems for Generating Dynamic Reward Currency Values” and U.S. patent application Ser. No. ______, filed Aug. 13, 2010, having attorney docket number 18113.105001, and entitled “A Universal System and Method for Loyalty Currency Redemption”.

### BACKGROUND OF THE INVENTION

I. Field of the Invention

The present invention generally relates to a system and method to facilitate redemption and use of non-monetary loyalty/reward currencies for purchases from merchants, including but not limited to in-store merchants, on-line merchants, mail order merchants, stand alone kiosks and vending machines. More particularly the present invention relates to mobile communications devices configured for wireless communication with systems configured to generate credit instruments in real time through the conversion of loyalty/reward non-monetary currency into monetary credit that may be used to purchase items. More particularly, the system and method relates to a platform utilizing a currency conversion system that facilitates conversion of non-monetary reward currency triggered via a mobile communications device into monetary credit for use in making purchases, wherein the monetary currency credit is loaded to an instrument that is accessible through a mobile device or loaded to a physical credit card, and valid for a defined period of time. The system and method facilitates redemption and conversion of a myriad of loyalty/reward currencies from a plurality of different loyalty/reward programs to temporary credit instruments for immediate use in the purchase of items from any one of a plurality of merchants.

II. Background Information

Mobile communication devices, such as cellular telephones, smartphones, pagers and hand-held personal digital assistants (“PDA's”), communicate information including at least one of voice and data over a wireless network. Mobile communication devices are being manufactured with increased competing capabilities and are becoming tantamount to personal computers. Some mobile communication devices, such as select cellular telephones, may have an installed application programming computer platform that allows software developers to create software applications that operate on the wireless communication device. Beyond their traditional communication functionality, mobile communication devices may additionally include the general functionality typically associated with a personal computer.

Systems for providing rewards to users have utilized personal computers and other dedicated computerized devices. One drawback associated with the use of personal computers, such as a desktop computer or a laptop computer, is that they are either not mobile or they are not conveniently operated while the user is moving about. Another drawback is that such systems only allow for on-line purchases. Other reward-based systems have utilized dedicated computerized devices to gather information from, or relay information to, a user. Such dedicated computerized devices, however, typically lack the functionality to make them useful to accomplish other tasks.

Accordingly, it would be desirable to provide a reward system that incorporates a multi-purpose mobile communications device that enables mobile access and use of reward currency for spontaneous purchases in retail locations.

To attract, retain and direct customers, employees and partners, an enterprise may provide a loyalty, motivation or similar reward program. In driving certain behavior, the program sponsoring enterprise distributes a non-monetary currency (e.g., points, miles or other) as an incentive to the program participants for achieving certain predefined objectives. The non-monetary currency distributed to the program participants as a reward can be redeemed by the program participants to purchase specific goods and services designated by the program sponsoring enterprise. For example, an airline's frequent flyer program provides non-monetary currency in the form of frequent flyer miles to customers participating in the frequent flyer program. The customer may redeem any accrued frequent flyer miles for free flights, upgrades, products, services, or other rewards designated by the loyalty provider's reward program.

In some situations, customers may not desire to purchase the items made available for redemption through the channels offered by the sponsoring organization. There is a need for methods and systems that allow a customer to use reward currencies not only for the products and services defined by the loyalty provider's reward program, but a system that facilitates the use of program reward currencies in the purchase of products that are not directly designated by the program sponsor. Furthermore, there is a need for a system and method that allows retailers to sell products and services which can be paid for with non-monetary currency that is converted to monetary currency by a conversion service provider.

There is a further need for methods and systems allowing the customer to utilize a mobile device to access reward currency for purchasing products and services. There is also a need to provide these methods and systems so that they will work with existing point of sale technology. Additionally, there is a need for a system that presents a customer that has accumulated reward currency with an option to purchase items that are not directly designated for purchase by a reward program sponsor through conversion of non-monetary currency to monetary currency that may be used to purchase items directly from retailers.

### SUMMARY OF THE INVENTION

Consistent with embodiments of the present invention, systems and methods are disclosed that enable generation of monetary currency using a mobile communications device for immediate use towards the purchase of items in a retail environment, wherein the monetary currency can comprise a credit instrument that is valid for a defined period of time, and generated from converting non-monetary reward currency into monetary currency based on a per unit non-monetary currency back up conversion value.

In accordance with one embodiment, monetary currency is generated on a mobile communications device upon a user accessing a currency module operating on the mobile communications device which facilitates user log-in to a currency account on a currency server, wherein the currency account of a user is associated with at least one loyalty program account of the user. On the mobile communications device, loyalty programs associated with the currency account are presented to the user who is provided an option of selecting one or more loyalty programs from which non-monetary currency shall be redeemed and converted into monetary currency using the per unit non-monetary currency back up conversion value. The user is also allowed to enter data representative of a purchase amount into a data field presented on the mobile communications device which is processed to determine an amount of non-monetary currency required to purchase the at least one item.

A currency server, which is operatively connected to the mobile communications device and a payment provider server transmits an inquiry to a loyalty program server upon which a selected loyalty program is maintained, to verify that the user's non-monetary currency balance is greater than or equal to the amount of non-monetary currency required to generate monetary currency having a value equal to the price of an item desired to be purchased. Upon verification, the user's non-monetary currency balance stored at the loyalty program server for the selected loyalty program shall be reduced by the amount of non-monetary currency required for conversion to generate the monetary currency required to make a desired purchase. The mobile communications device receives from a payment provider server, via a currency server, a temporary credit instrument equaling the amount of monetary currency required to make a purchase, wherein the credit instrument must be used by the user within a defined period of time before expiration. In alternate embodiments, instead of the mobile device receiving a credit instrument, the payment provider can issue a credit that is activated through a credit or debit account associated with a plastic credit or debit card in the user's possession.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description and include systems and methods for generating temporary credit instruments equaling the amount of non-monetary currency required to purchase the at least one item that must be used by the user within a defined period of time before expiration.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram depicting a system for implementing the method of redeeming loyalty/reward currency for retail purchases at retailer locations through use of a mobile device.

FIG. 2A and FIG. 2B is a flow chart of an exemplary method of redeeming loyalty/reward currency for retail purchases at retailer locations that may not be affiliated with a specified reward currency through use of a mobile device, consistent with an embodiment of the present invention.

FIG. 3 is an illustration of an embodiment of the present invention showing the graphical user interface for system login through use of a mobile device on a mobile application platform.

FIG. 4 is an illustration of an embodiment of the present invention illustrating a graphical user interface on mobile device on a mobile application platform for the system at which a user selects a preferred loyalty program account, from a plurality of user loyalty program accounts, from which to redeem non-monetary currency to purchase a retail item.

FIG. 5 is an illustration of an embodiment of a confirmation screen following successful authentication that a user has a sufficient non-monetary currency balance to cover the price of an item desired for purchase.

FIG. 6 is another illustration of an embodiment of the present invention illustrating a graphical user interface for the system at which a user selects a preferred loyalty program account, from a plurality of user loyalty program accounts, from which to redeem non-monetary currency to purchase a retail item.

FIG. 7 is an illustration of an embodiment of the present invention of a graphical user interface for user login into a loyalty program account within the user account following selection of the loyalty program account from a plurality of accounts.

FIGS. 8A and 8B are illustrations of an embodiment of the present invention showing a graphical user interface for entering and receiving information relating to redeeming loyalty points for a monetary amount.

FIGS. 9A and 9B are illustrations of an embodiment of the present invention showing a graphical user interface relating to receiving a monetary credit.

FIG. 10 is a flow chart of an exemplary method of redeeming loyalty currency for monetary currency in accordance with an embodiment of the invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

Systems and methods consistent with embodiments of the present invention may be used to facilitate the use of non-monetary reward currency in retail purchases at retail locations wherein a non-monetary currency selected and converted to monetary currency in the form of a credit instrument is temporarily issued and transmitted to the mobile device of a user for use in an in-store purchase of an item having a price equal to the amount of the credit instrument provided. A system is wirelessly accessed by the mobile communication device to facilitate the conversion of non-monetary reward currency, accumulated in a reward program, to a credit instrument. The credit instrument being valid for a defined period of time, may be used for purchases when the credit instrument is presented at the point of sale to purchase items.

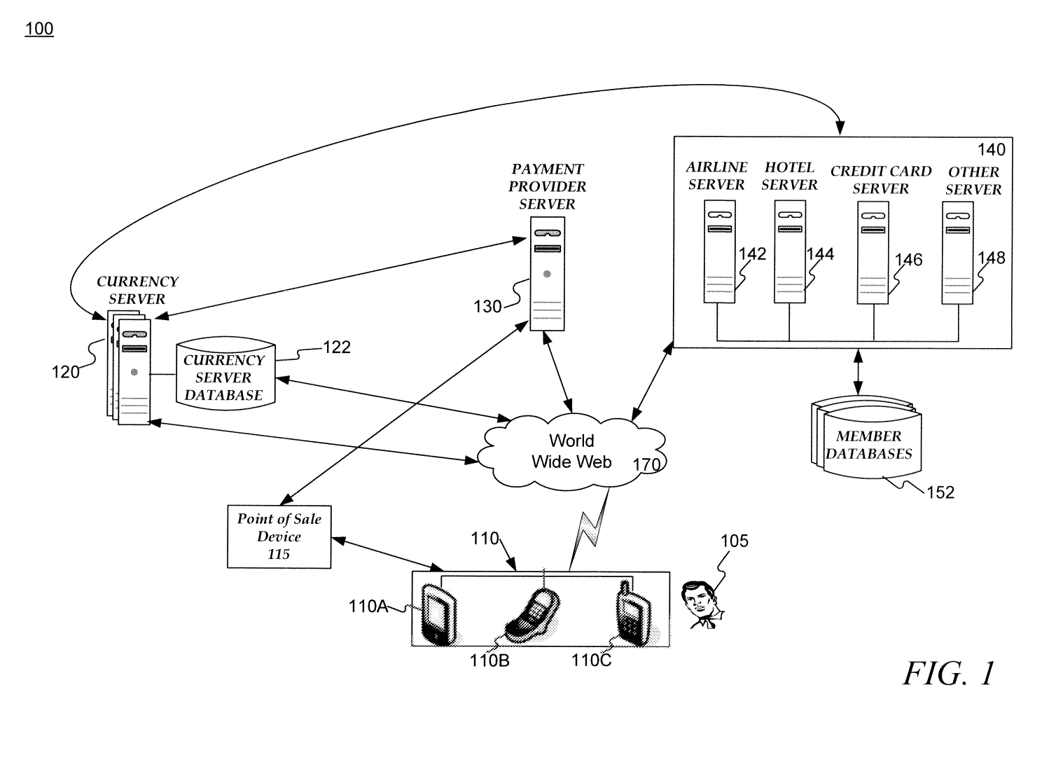

A customer uses a mobile communication device, which may include a mobile phone, PDA or any other mobile communications device that facilitates roaming mobile web access through a WIFI or mobile network connection. The customer uses the mobile communication device to generate a credit instrument in real-time in a retail environment upon the user determining that it is desirable to redeem and convert non-monetary currency for use in the purchase of an item in a retail environment. Upon the user making such a determination, the user accesses a system through the use of a mobile communication device. As illustrated in FIG. 1, the system comprises a currency server 120, at least one loyalty program sever 140, and a payment provider server 130, in one embodiment wherein the mobile communication device 110 is operatively connected to the currency server 120 and the payment provider server 130 through at least the world wide web 170. In an alternative embodiment, the mobile communication device 110 is operatively connected to the currency server 120 and the payment provider server 130 through a mobile telephone communications wireless protocol. The currency server 120 is operatively connected to the payment provider server 130 and the at least one loyalty program server 140, wherein a user receives a credit instrument on the mobile communication device 110 directly from the payment provider server 130 generated from converting non-monetary reward currency verified as existing in a user's loyalty program account stored on a loyalty program server 140 into monetary currency.

Those of skill in the art will recognize that the loyalty program server 140, also referred to as the reward server, can take a variety of forms and may comprise one or more servers associated with one or more loyalty programs. For example, as illustrated in FIG. 1, the loyalty program server 140 comprises an airline server 142, a hotel server 144, a credit card server 146, and another type of server 148, each of which is associated with a loyalty program. It should also be recognized that other types of servers associated with other types of financial rewards beyond conventional loyalty programs can be associated with loyalty program server 140. For example, a server associated with a user financial account could be associated with the loyalty program server 140 and the financial account could be used to issue credits to mobile communication devices.

The system illustrated in FIG. 1 implements a method of generating monetary currency on a mobile communications device 110, wherein the monetary currency comprises a temporary credit instrument having a relatively short valid instrument window of time, and wherein the credit instrument is generated from converting non-monetary reward currency into monetary currency in the form of a credit instrument. The user accesses a currency software module operating on the mobile communications device 110 which facilitates log-in by a user to a currency account stored on the currency server database 122, wherein the currency account of a user is associated with at least one loyalty program account of the user. The currency module presents on the mobile communications device 110, loyalty programs associated with the currency account and provides the user with an option to select a loyalty program from which non-monetary currency shall be redeemed and converted to the monetary currency. The currency module also presents a data field on the mobile communications device 110 to the user wherein data representative of a purchase amount for an item desired to be purchased is input and processed in order to determine an amount of non-monetary currency that needs to be converted to monetary currency in the form of a credit instrument that may be used in the purchase of an item in a retail environment.

The currency server software module installed on the currency server 120 receives communications from the mobile communications device 110 and can communicate with the payment provider server 130 and the loyalty program server 140. Upon a determination of the amount of non-monetary currency required to be converted to monetary currency, the currency server 120 transmits an inquiry to a loyalty program server 140 upon which the selected loyalty program is maintained, to determine whether the user's non-monetary currency balance is greater than or equal to the amount of non-monetary currency required to be converted to monetary currency. The loyalty program account of the user stored in member database 152 of the loyalty program server 140 includes at least data representative of accumulated non-monetary currency of the at least one loyalty program.

Upon verification by the currency server 120 that the user's non-monetary currency balance is greater than or equal to the amount of non-monetary currency required to purchase the at least one item, the user's non-monetary currency balance stored at a loyalty program server 140 for the selected loyalty program is reduced by the amount of non-monetary currency calculated as being required for conversion to monetary currency for use in the purchase of the at least one item desired to be purchased. In one embodiment, the verification by the currency server 120 of whether the user's non-monetary currency balance is greater than or equal to the amount of non-monetary currency required to purchase the at least one item is performed on the currency server 120 locally and not through a connection to the loyalty program server 140. In the embodiment illustrated, data representative of the accumulated non-monetary currency is transmitted to the currency server 120 from the loyalty program server 140 at defined intervals and data representative of the accumulated non-monetary currency value is updated and stored on the currency server 120. In this embodiment, the currency server sends an instruction to the loyalty program server 140 to reduce the user's non-monetary currency balance stored at a loyalty program server 140 for the selected loyalty program by the amount of non-monetary currency calculated as being required for conversion to monetary currency for use in the purchase of the at least one item desired to be purchased.

Following a reduction of the user's non-monetary currency balance stored at a loyalty program server 140, the currency server transmits a request to the payment provider server 130 to generate a temporary credit instrument and transmit the temporary credit instrument to the mobile communications device 110. The payment provider server 130 is typically operated by a financial institution, such as a bank that issues a credit or debit card. However, in other embodiments the payment provider server 130 is not required to be operated by a conventional financial institution. The payment provider server 130 processes the instruction from the currency server 120 and determines there from the monetary currency amount of the credit instrument. The credit instrument generated equals the amount of monetary currency required to purchase an item desired to be purchased. The currency server software module operating on the currency server 120 receives the credit and forwards it to the mobile communications device 110. The currency server 120 also can determine the length of time that the credit instrument shall be valid and identification data associated with the mobile communication device. The user may utilize the credit instrument stored on the mobile communications device 110 to purchase the item desired. In one embodiment, the user can transmit the credit from the mobile communications device 110 to a point of sale device 115.

In a reward program, a user may earn or otherwise receive non-monetary currency that may be used to redeem a reward. The non-monetary currency may comprise, but is not limited to, general rewards points, airline frequent flyer miles, or other non-monetary reward currency associated with financial or non-financial accounts. The non-monetary currency may be associated with or otherwise related to any one of a plurality of loyalty reward programs (for example, a program directed toward consumers), motivation programs (for example, directed towards employees or distributors), or any other program that may leverage a non-monetary currency in order to reward specific behavior. The aforementioned are exemplary and the non-monetary currency may comprise other non-monetary qualities.

Once a non-monetary reward currency is received, the user may wish to redeem a reward by exchanging the non-monetary currency for products, services, or a combination of products and services selected, for example, by the user. Generally, non-monetary currency may be used to purchase products and services offered by the program sponsor, since other retailers and program sponsors receive little if any benefit from allowing a user to redeem another loyalty program sponsor's reward to a customer. Allowing a customer to use non-monetary currency to purchase products and services offered by the program sponsor is generally done to enhance customer loyalty. A limitation of current loyalty program functionality is that rewards generated by a customer may have limited value if the products for which the rewards may be exchanged are not of particular value to the customer. The present invention adds breadth to the products and services for which a non-monetary currency reward may be exchanged by enabling the use of non-monetary currency to facilitate the purchase of goods and services when the user of the system is shopping at a retail establishment. Previously, use of non-monetary currency was limited to on-line purchases from retailers or program sponsors having an affiliation with the reward program. In addition, products and services available for on-line purchases were limited and users could not use the non-monetary reward currency for impulse purchases while out visiting retail locations. Consistent with embodiments of the present invention, the system disclosed herein is used in conjunction with current loyalty programs and systems to remove limitations on the types of products and venues for which non-monetary currency may be used to purchase goods and services.

Utilizing the system disclosed in the present invention enables a user to use non-monetary currency to purchase goods and services at retailer outlets having no affiliation with the user's loyalty program or any infrastructure capable of accepting the user's non-monetary currency accumulated in a loyalty/reward program. In addition, the present invention is equipped with a software module configured with an algorithm that may be used to calculate currency components of a payment pair, comprised of a monetary currency component and a non-monetary currency component, that may be used to purchase goods or services identified by a user.

In one embodiment, identifying and inputting either a monetary currency or non-monetary currency amount, results in the generation of a specific payment pair comprised of the currency component input and a corresponding non-monetary component or vice versa. In another embodiment, the software module may generate a plurality of payment pairs that include calculated currency payment pair values wherein each payment pair comprises, for example, a non-monetary currency component and a monetary currency component. The monetary currency component may comprise a cash amount and may relate to, for example, any known monetary currency. For each payment pair, the combination of the non-monetary and monetary components may correspond to the retail price of the selected good or service or the selected good or service's cost to the reward program member. Furthermore, typically no two non-monetary currency component values within the plurality of payment pairs may be the same. Likewise, typically no two monetary currency component values within the plurality of payment pairs may be the same. Moreover, the value of the non-monetary currency component multiplied by a corresponding currency value plus the monetary currency component value may be equal to the cost value of an item desired to be purchased.

When the user wishes to redeem non-monetary currency to purchase a good or service from a retailer, the present invention provides the user with an option of using non-monetary currency only, non-monetary currency in combination with monetary currency or monetary currency alone. When the user desires to use a combination of monetary and non-monetary currency, the user may determine the amount of monetary currency that shall be used in combination with non-monetary currency to purchase an item. The user inputs the desired amount of monetary currency into the system via the system's currency values software module. Upon input of the monetary currency, the currency values software module presents a payment pair comprised of a non-monetary currency component and the monetary currency component input. The non-monetary currency component is generated by the currency values software module in direct response to the monetary currency amount input. The payment pair presented to the user may be accepted, rejected or modified. If the payment pair is rejected, the user is provided with an opportunity to modify either of the monetary or non-monetary currency components of the payment pair, which shall generate an alternate payment pair comprising different monetary and non-monetary currency components values.

As an alternative, if the user is not aware of the amount of monetary currency they would like to use and also does not have enough non-monetary currency to purchase a desired item, the user may input an amount less than the required level of non-monetary currency into the system to purchase an item. Upon the input of the non-monetary currency amount, the currency values software module generates a payment pair comprised of the non-monetary currency amount input and a generated monetary currency amount. It is to be understood that the currency values software module is flexible and is not limited to a specific number of payment pairs. Payment pairs are generated based on the input values of the monetary or non-monetary currency amounts. Consequently, the user may choose any point along, for example, a monetary currency and non-monetary currency continuum as a preferred method of paying for the selected good or service.

In one exemplary embodiment, the monetary currency and non-monetary currency continuum is illustrated by way of a slider module which represents a graphical user interface that comprises an interactive slider which begins at a first end of the currency continuum with a payment pair comprising a non-monetary currency component and a monetary currency component equal to at least one of an amount of zero dollars and an amount of close to zero dollars and ends at a second end of the currency continuum with a payment pair comprising a monetary currency component and non-monetary currency component equal to one of an amount close to zero units and an amount of zero units. The interactive slider facilitates the presentation of a plurality of payment pairs through movement of the slider along the payment pair continuum, wherein a plurality of payment pairs may be presented to the user upon the user moving the slider over a plurality of points along the payment pair continuum. Through use of the interactive slider a user generates a plurality of unique payment pairs along the payment pair continuum until a preferred payment pair is identified and selected. A payment pair including both a monetary and a non-monetary component has the monetary component associated with a financial account of the user. In one embodiment, the monetary component may be debited by an amount equal to the monetary currency value associated with the user selected payment pair. Likewise, the rewards currency account selected by the user as currency for a respective purchase may be debited by an amount equal to the non-monetary currency value associated with the user generated and/or selected payment pair.

The aforementioned algorithm within the currency values software module may use as few or as many parameters as desired. Moreover, the algorithm may assign more value, for example, to the value of each incremental unit of non-monetary currency (e.g., each point) the greater the monetary currency value within a respective payment pair. For example, a system user desires to redeem non-monetary currency for goods or services. In this example, the item to be purchased has a retail value of $100, and four potential payment pairs are discussed. The first payment pair may have a 20,000 unit non-monetary currency component and a $0 monetary currency component. The second payment pair, for example, may have a 9,000 unit non-monetary currency component and a $50 monetary currency component. The third payment pair, for example, may have a 1,000 unit non-monetary component value and a $90 monetary currency component. The fourth payment pair, for example, may have a 0 unit non-monetary component value and a $100 monetary currency component value.

In accordance with the above example, each unit of the 20,000 units of non-monetary currency in the first payment pair's non-monetary currency component may be given a $0.0050 value. Because the second and third payment pair's monetary currency component values are greater than the first payment pair's monetary currency component value, each incremental unit in the second and third payment pair's non-monetary currency component may be given values of $0.0055 and $0.0100 respectively. The non-monetary currency component value in both the second and third payment pairs are greater than each incremental unit in the first payment pair's non-monetary currency value.

Accordingly, because the reward program member is provided the freedom to choose their desired payment strategy, and thereby generates a personalized payment pair, they are also offered the fourth payment pair where they could pay in monetary currency only and, for example, accrue non-monetary currency units for each dollar spent instead of redeeming points. It is contemplated that the universal payment system may be configured to generate universal non-monetary currency units for each dollar spent instead when points are not redeemed and purchases are made with cash alone. The universal non-monetary currency units generated may be combined with the specific non-monetary currency units of a loyalty reward program at the time subsequent purchases are made.

Embodiments of the invention may be practiced in concert with existing loyalty and reward program systems wherein each loyalty program account of the user is associated with a currency account on a currency server in order to facilitate flexibility by the user in determining the reward program currency to be converted into monetary currency using the per unit non-monetary currency back up conversion value.

Consistent with an embodiment of the present invention, the aforementioned system including memory, processing unit, and other components including a mobile communications device, are configured to implement a method of facilitating redemption, conversion and use of loyalty/reward currencies for retail purchases from retailers on-site at a retail location, wherein the retailer may not be affiliated with a specified reward currency or loyalty program. The method utilizes the non-monetary currency within a platform of systems networked to facilitate retail purchases from retailer systems that do not recognize the non-monetary currency as a vehicle for use in purchasing retail items. The system and method facilitates redemption and conversion into monetary currency of a myriad of loyalty/reward currencies from a plurality of different loyalty/reward programs. The conversion of non-monetary reward currency into monetary currency is performed using a per unit non-monetary currency back up conversion value associated with a specific loyalty/reward program.

Such a system that performs redemption and conversion of loyalty/reward currencies to facilitate purchases from merchants that may or may not be affiliated with a specified reward program, wherein the conversion and initiation of the transaction occurs in the field using a mobile communication device, configured to perform computer processing, is illustrated in FIG. 1. Any suitable combination of hardware, software, and/or firmware may be used to implement the memory, processing unit, or other components. By way of example, the memory, processing unit, or other components may be implemented with any server shown in FIG. 1, including, at least a mobile communication device 110, configured to perform computer processing, and, for example, a currency server 120, in combination with system 100. The aforementioned system, including a mobile communication device 110, and server are exemplary and other systems and servers may comprise the aforementioned memory, processing unit, or other components, consistent with embodiments of the present invention.

By way of a non-limiting example, FIG. 1 illustrates a system 100 in which the features and principles of the present invention may be implemented. As illustrated in FIG. 1, system 10 may include a plurality of mobile user interface devices 110 such as a PDA 110A, and mobile phone 110B and a smart phone 110C. Each user 105 may gain access to a currency server 120 by way of an Internet or World Wide Web connection 170 through the mobile communications devices 110. The user 105 accesses a currency software module operating on the mobile communications device 110 which facilitates log-in by a user 105 to a currency account stored on the currency server database 122, wherein the currency account of a user 105 is associated with at least one loyalty program account of the user. A currency server software module installed on the currency server 120 manages communications with the mobile communications device 110 and the other computing components illustrated in exemplary FIG. 1.

The currency module presents on the mobile communications device 110, loyalty programs associated with the currency account and provides the user with an option to select a loyalty program from which non-monetary currency shall be redeemed and converted to the monetary currency. The currency module also presents a data field on the mobile communications device 110 to the user wherein data representative of a purchase amount for an item desired to be purchased is input and processed in order to determine an amount of non-monetary currency that needs to be converted to monetary currency in the form of a credit instrument that may be used in the purchase of an item in a retail environment.

Following the input of data representative of a purchase amount for an item desired to be purchased, the currency software module operating on the mobile communications device 110, through the currency server 120, presents data representative of the reward program accounts associated with the currency account. The information representative of the reward currency accounts may be stored within the currency accounts on the currency server 120 and updated periodically in accordance with batch timing updates previously defined. Alternatively, the information representative of the currency accounts is not stored on the currency server 120, but is accessed in real time from the appropriate loyalty program server 140.

In one embodiment, upon the user 105 accessing their respective currency account within the currency server 120, the currency server 120 requests information from a plurality of reward program servers 140 that is representative of at least total amount of non-monetary currency accumulated in each reward program account associated with the currency account of the user.

Following a verification by the currency server 120 that the user's non-monetary currency balance within the selected loyalty program account is greater than or equal to the amount of non-monetary currency required to purchase the at least one item, the user's non-monetary currency balance stored at a loyalty program server 140 for the selected loyalty program is reduced by the amount of non-monetary currency calculated as being required for conversion to monetary currency for use in the purchase of the at least one item desired to be purchased. Next, the currency server 120 transmits a request to the payment provider server 130 to generate a temporary credit instrument and transmit the temporary credit instrument to the mobile communications device 110. The instruction can include data representative of the amount of the credit instrument, the window of time of which the credit instrument is to be valid and the identification data associated with the mobile communications device.

The payment provider server 130 processes the instruction from the currency server 120 and determines there from the amount of the credit instrument. The credit instrument generated by the payment provider server 130 equals the amount of monetary currency required to purchase an item or items. In one exemplary embodiment, the currency server 120 receives the credit from the payment provider server 130 and forwards the credit to the mobile communications device 110. In one exemplary embodiment, the currency server 120 also can determine the length of time that the credit instrument shall be valid and the identification data for the mobile communication device address to which the credit instrument is to be sent. The user 105 may utilize the credit at a point of sale device 115 at a retailer, a vending machine, or other location where goods or services are sold.

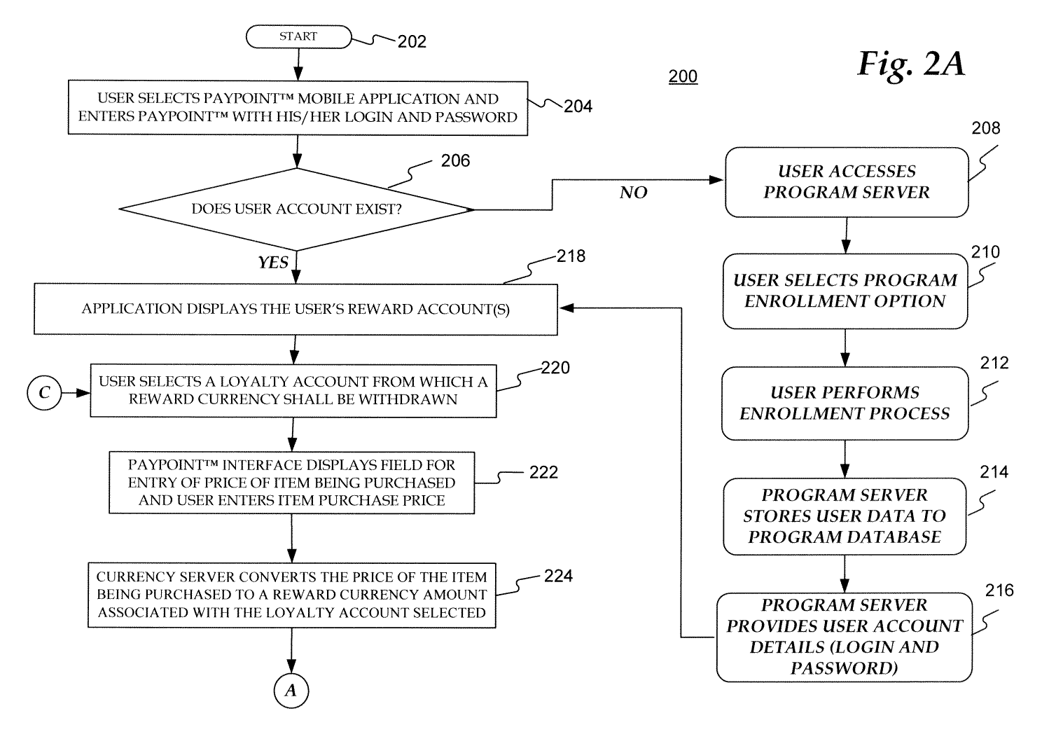

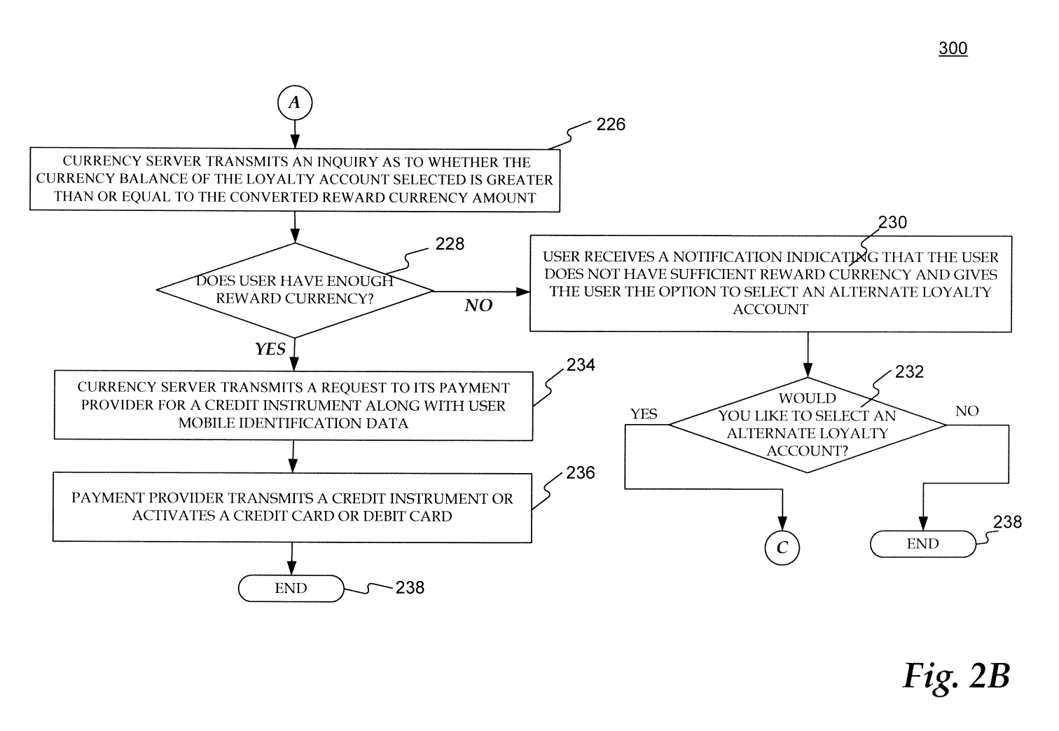

FIGS. 2A and 2B contain a flow chart setting forth the general stages involved in an exemplary method consistent with the invention for instantaneously generating monetary currency on a mobile communications device for immediate use towards the purchase of items in a retail environment. The monetary currency comprises a credit instrument that is valid for a period of time, and generated from converting non-monetary reward currency into monetary currency based on a per unit non-monetary currency back up conversion value. Using for example, system 100 illustrated in FIG. 1, the exemplary method describes a process for connecting to a currency server and accessing a currency account connected to a plurality of loyalty program reward accounts, at least one of which a user may select to have reward currency converted from non-monetary currency into monetary currency in accordance with the backup value per non-monetary currency unit issued. Wherein, following conversion, the monetary currency is forwarded to the mobile communications device in the form of a credit instrument which may be used at a point of sale device by a consumer. Exemplary ways to implement the stages of the exemplary method will be described in greater detail below. The exemplary method illustrated in FIGS. 2A and 2B begins at starting block 202. Consistent with the method, user 105 may wish to purchase an item from a retailer at the retail location while out shopping. The user may desire to generate monetary currency from loyalty program currency using a mobile communications device 110 for immediate use towards the purchase of items at a point of sale in a retail environment.

On a mobile communications device 110, such as a PDA 110A, mobile phone 110B or smart phone 110C, the user 105 accesses a currency module interface operating on the mobile communications device operating system. The currency module includes a graphical user interface that may be accessed upon engaging an icon within the operating system of the mobile communications device. The currency module facilitates a direct connection to the currency server 120, which functions as a central server for the reward currency system illustrated in FIG. 1, which is also referred to herein as the POINTSPAY™ system or the PAYPOINT™ system. On the mobile communications device, the user selects an icon associated with the currency module in order to initiate the method 200 and is presented with an opportunity to enter the currency module operating on the mobile communications device 110. Upon entering the currency module, the user is presented with an option to enter his/her login and password information and enters the information into defined data fields in step 204. If the user does not have a currency account in step 206, the user may select an icon indicating that the user is not a member of the POINTSPAY™ program. Next, the user 105 shall be provided with an opportunity to create a currency account. Users that select the option to create a currency account are provided access to the currency server in step 208. Next the user is provided with an option to select a program enrollment in step 210. Following the entry of specific data into data fields associated with enrolling into the POINTSPAY™ currency system, in step 212, the currency server 120 stores the data entered by the user 105 into the currency server program data base in step 214. Next, the program server configures a currency account for the user 105 and transmits the details of the user login and password data to the user, in step 216, at mobile communication device 110 so that the user 105 may access their respective currency account within the POINTSPAY™ currency system.

During the enrollment process, the user is provided with an opportunity to enter data representative of or selected from a list of loyalty program accounts associated with the user's currency account within the POINTSPAY™ currency system so that the loyalty programs of which the user 105 is affiliated may be associated with their respective currency account within the POINTSPAY™ currency system that the user created during the enrollment process. The user 105 generally will be required to include at least data representative of a user's account number, login and password associated with a specific loyalty program account. A user 105 accessing the currency server 120 through a mobile communication device that was previously enrolled in the POINTSPAY™ currency program, shall be prompted to enter their respective login and password data in step 204. Assuming the user has an account at step 206, the currency module operating on the mobile communication device 110 connects wirelessly to the currency server 120 located remote from the mobile communications device through a WIFI or mobile telephony connection. The currency server 120 transmits select data associated with the currency account to the mobile communication device 110 where the data is displayed to the user in step 218. For example, the data displayed on the mobile communications device 110 typically identifies the user's loyalty programs. The displayed data can also include the user's account balance for each reward account associated with the currency account and some additional personal identification data in step 218.

Next, from the list of reward accounts displayed as being associated with the currency account, the user may select a loyalty account from which a reward currency is to be withdrawn in step 220. The currency module, operating on a mobile communication device, interface displays a data field for entry of pricing information for an item or items a user 105 would like to purchase and allows the user 105 to enter the pricing information into a defined data field in step 222. The pricing information entered into the data field is processed and thereby converted into a reward currency amount from which the loyalty program account selected shall be deducted in step 224.

It is to be understood that in one embodiment, the process of converting the pricing amount associated with the item to be purchased may be performed on the mobile communication device by the currency module. In an alternative embodiment, the process of converting the pricing amount associated with the item to be purchased may be performed on the currency server 120 following the currency module initiating the transmission of the pricing amount to the currency server 120 where the monetary currency amount is converted into a non-monetary reward currency amount. Regardless of where the process of converting the pricing amount associated with the item to be purchased is performed, the conversion from a monetary currency amount to a non-monetary currency amount is performed using a per unit non-monetary currency back up conversion value. For example, if the loyalty program issues rewards in points, each point may have a respective conversion value of 0.01. Such per unit non-monetary currency back up conversion values vary heavily among loyalty programs and typically will depend on an enterprise's cost structure and/or general margin as well as the industry's competitive environment.

Following a determination of the value of non-monetary currency for the selected loyalty/reward program that the pricing information entered into the data field converts to in response to processing the pricing amount, an inquiry is transmitted to the selected loyalty program server 140 with an inquiry as to the balance of the loyalty program rewards. Specifically, the inquiry seeks to determine whether the balance of the loyalty program account is greater than or equal to the converted reward currency amount in step 226. The currency server 120 determines whether the non-monetary currency balance within the loyalty reward program account selected has enough currency to cover the converted non-monetary currency generated from the pricing information entered by the user in step 228. If a loyalty program account balance is less than the amount of non-monetary currency generated from processing the pricing information, the currency server transmits a notification to the user 105 at the mobile communication device (or the mobile communication device sends a notification generated locally) indicating that the user 105 does not have a sufficient level of rewards currency to complete the transaction in step 230.

On the mobile communication device 110 the user 105 is prompted with the option to select one or more alternate loyalty program accounts from which non-monetary currency may be converted and deducted in order to complete the proposed retail transaction in step 232. In other embodiments, the user may combine different types of reward currency or reward currency with monetary currency. If the user 105 decides that selection of an alternative loyalty program account is not the manner in which they would like to proceed, the transaction ends in step 238.

Alternatively, if the user 105 determines that he or she would like to select an alternate loyalty program account, the user 105 shall be presented with a list of loyalty program accounts associated with the currency account via the currency module on the mobile communication device in step 218.

Under circumstances where the user 105 has sufficient reward currency in their respective loyalty program account in step 228, the currency server 120 transmits a request to a payment provider server 130 (typically a financial institution) that functions as a payment provider for processing the request in step 234. Next, the payment provider server 130 issues a credit instrument along with user mobile communication device identification data in step 236. The payment provider server 130 transmits a credit either directly to the mobile communication device 110 or to the currency server 120 for forwarding to the mobile communication device 110. The mobile identification data stored at the currency server 120 allows for transmission of the credit to the mobile communication device 110. In exemplary embodiments, the credit includes a credit instrument that includes a specific credit card number as shown in step 236. In certain embodiments, the currency server 120 can also transmit the time period during which the credit instrument is valid to the mobile communication device 110. The validity period generally will not last more than several hours, however, the length of the actual validity period is not critical so long as the time during which the credit instrument is valid is long enough to preserve security associated with the credit instrument. It is possible that in alternate embodiments a credit instrument could be issued without a predefined validity period. Upon receipt of the credit instrument, the user may then utilize the credit instrument to purchase goods and services at a point of sale or on-line.

In alternate embodiments, instead of issuing a credit to the mobile device, the payment provider server 120 can issue a credit to a credit account associated with a credit card or a debit account associated with a debit card. The payment provider server 120 can send a notice to the currency server 120 or directly to the mobile communication device 110 that the credit has been applied to the user's credit card or debit card. The user can then use the credit card or debit card in his or her possession that is identified in the notice from the payment provider server 120 to make a purchase.

Any of the servers in FIG. 1 including currency server 120, (“the servers”) included in system 100 may be implemented using a personal computer, network computer, mainframe, or other similar microcomputer-based workstation. The servers may comprise any type of computer operating environment, such as hand-held devices, multiprocessor systems, microprocessor-based or programmable sender electronic devices, minicomputers, mainframe computers, and the like. The servers may also be practiced in distributed computing environments where tasks are performed by remote processing devices. Furthermore, any of the servers may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the servers may comprise other systems or devices.

The network upon which the system functions may comprise, for example, a local area network (LAN) or a wide area network (WAN). Such networking environments are commonplace in offices, enterprise-wide computer networks, intranets, and the Internet. When a LAN is used, a network interface located at any of the servers may be used to interconnect any of the servers. When the network is implemented in a WAN networking environment, such as the Internet, the servers may typically include an internal or external modem (not shown) or other means for establishing communications over the WAN. Further, in utilizing a network, data sent over network infrastructure may be encrypted to insure data security by using known encryption/decryption techniques.

In addition to utilizing a wire line communications system as the communications network, a wireless communications system, or a combination of wire line and wireless may be utilized as the network in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The servers in the wireless environment can be any mobile terminal, such as the mobile terminals described above. Wireless data may include, but is not limited to, paging, text messaging, e-mail, Internet access, and other specialized data applications specifically excluding or including voice transmission.

System 100 may also transmit data by methods and processes other than, or in combination with, the network. These methods and processes may include, but are not limited to, transferring data via, diskette, CD ROM, facsimile, flash memory sticks, conventional mail, an interactive voice response system (IVR), or via voice over a publicly switched telephone network.

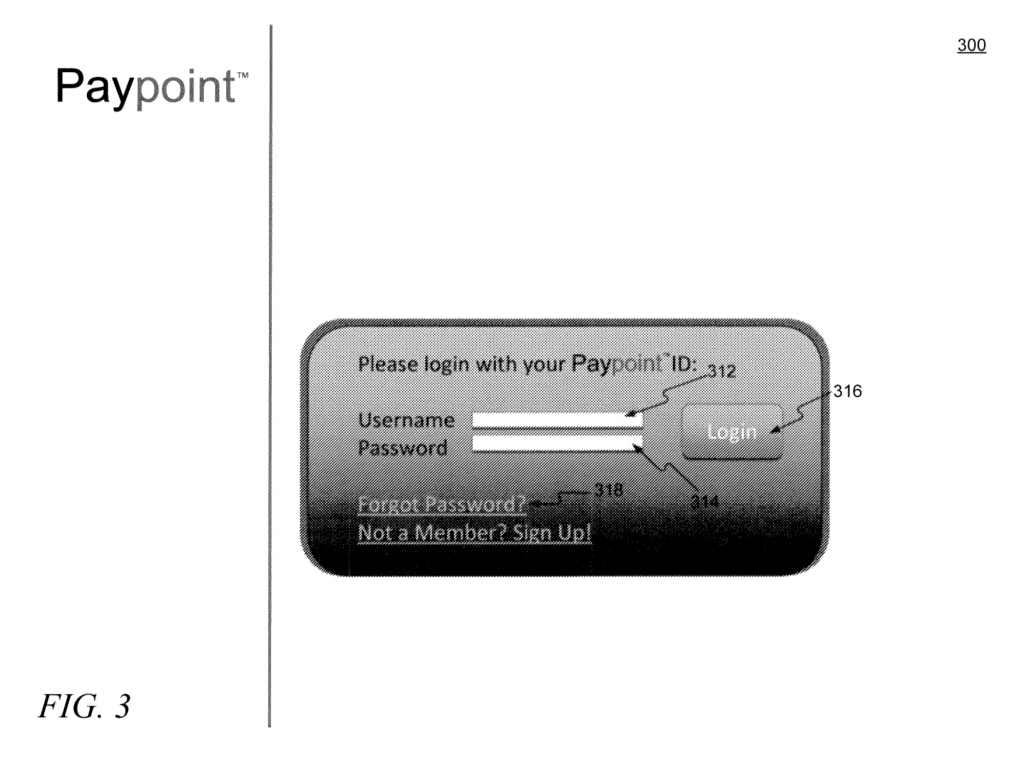

The graphical user interface presented to a user 105 of the system and method through the currency software module operating on a mobile communication device is illustrated in the exemplary embodiments shown in FIGS. 3 through 9B. More specifically, FIG. 3 illustrates a graphical user interface 300 presented on the mobile communication device following a user 105 selecting a PAYPOINT™ currency conversion icon on the application operating system on the mobile communication device. Specifically, the currency software module operating on the mobile communication device 110 allows the user to login to the currency server 120 and thereby the POINTSPAY™ system by entering a username 312 and password 314 into respective data fields presented by the currency software module in graphical user interface 300.

Following entry of a username and password into the respective data fields of graphical user interface 300, the user 105 may initiate processing of the data entered by engaging the login process button 316 which initiates processing of the username and password. The graphical user interface 300, presented on the mobile communication device following a user 105 selecting the currency module on the mobile communication device also includes a process whereby a user 105 that does not know their respective password may have the password sent to the mobile communication device 318. Graphical user interface 300 also includes a link directing a user 105 to the member sign up process, when the user is not a member of the POINTSPAY™ system, upon selection of link 320.

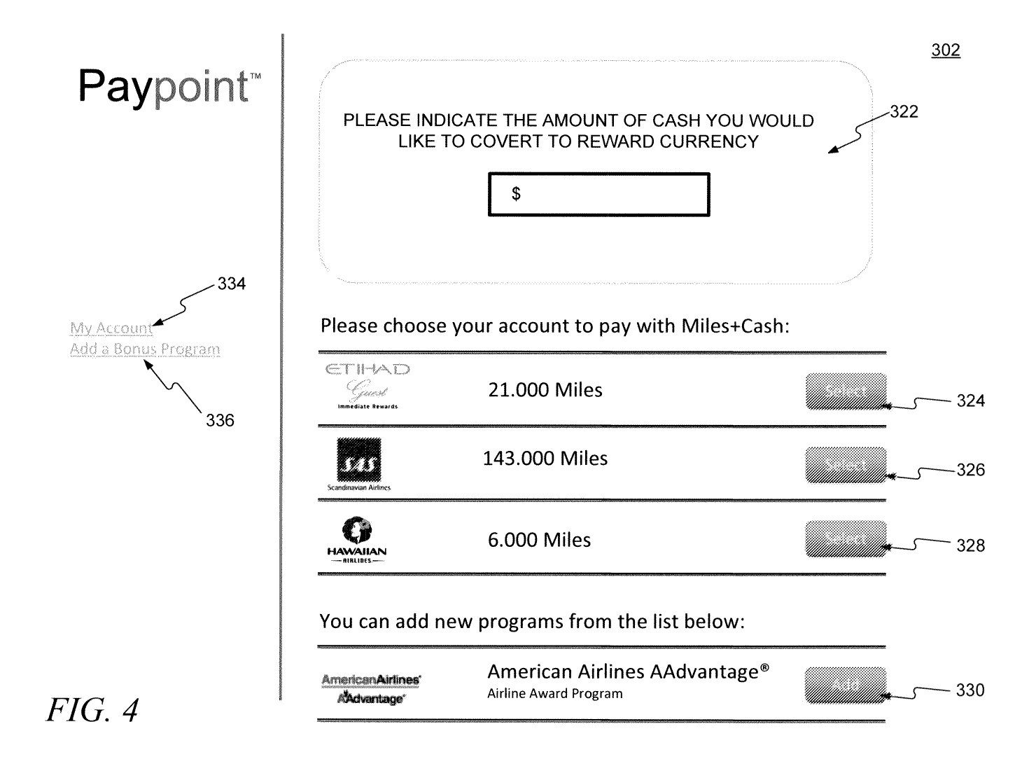

Following entry of data representative of a username 312 and password 314 into respective data fields presented by the currency module in graphical user interface 300, the user is presented with graphical user interface 302, illustrated in FIG. 4. As illustrated in FIG. 4, the graphical user interface 302 allows the user 105 to indicate the amount of cash the user would like to convert to reward currency by entering data representative of that respective currency amount into data field 322. In the embodiment illustrated in graphical user interface 302, loyalty/reward programs associated with the user's POINTSPAY™ system account are illustrated along with the accumulated reward balances for each respective loyalty program account. In the example illustrated, a user may select one of three loyalty programs from which to convert non-monetary currency into monetary currency. A first program account, having a reward currency of 21,000 miles may be chosen by selecting button 324. A second program account, having a reward currency of 143,000 miles may be chosen by selecting button 326. A third program account, having a reward currency of 6,000 miles may be chosen by selecting button 328. The graphical user interface 302 also allows a user 105 to add new reward programs that will then be associated with the user's POINTSPAY™ system account by selecting the add button 330.

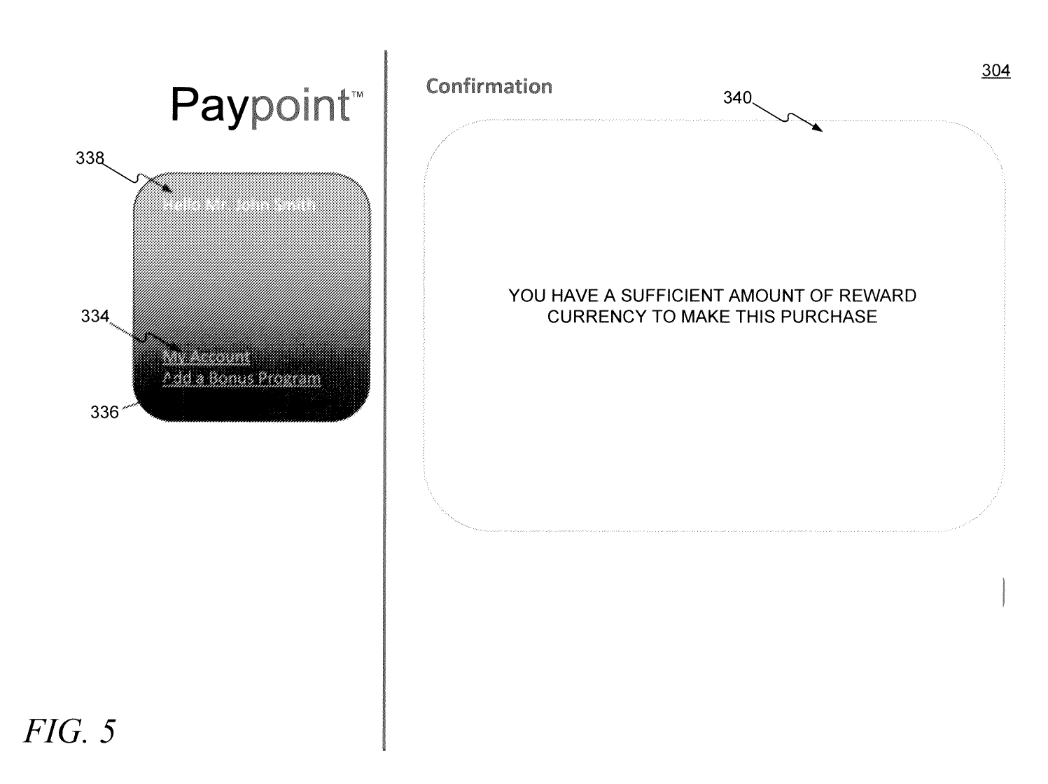

Upon making a selection of a reward account by engaging one of the reward account selection buttons 324, 326, 328, the user is presented with exemplary graphical user interface 304 illustrated on FIG. 5 wherein a message 340 is presented to the user 105 indicating that the user 105 has a sufficient amount of reward currency necessary to make the purchase. Graphical user interface 304 illustrated on FIG. 5 also includes presentation of data representative of the name of the user 338, a link back to the user's account 334 and a link to add a bonus program 336.

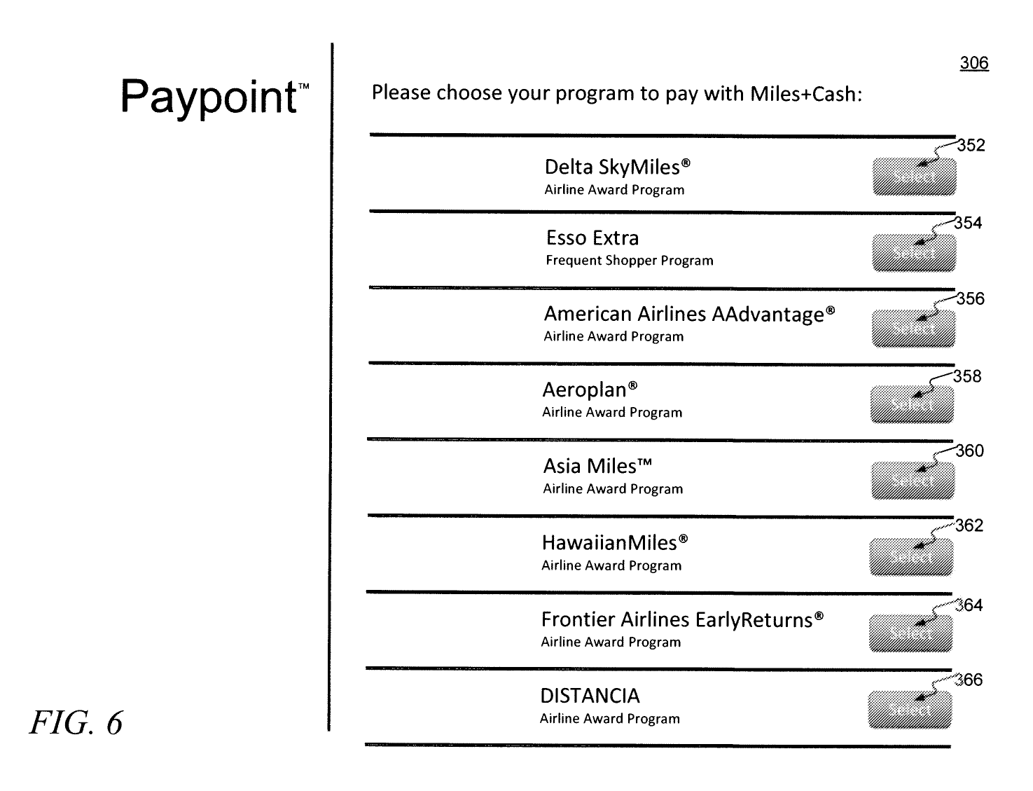

As illustrated in FIG. 6, the user is presented with exemplary graphical user interface 306 wherein loyalty/reward programs associated with the user's POINTSPAY™ system account are illustrated. In the example illustrated, a user may select one of eight loyalty programs 352, 354, 356, 358, 360, 362, 364, 366 from which to convert non-monetary currency into monetary currency. In the example illustrated, the user selects a first loyalty program by selecting button 352.

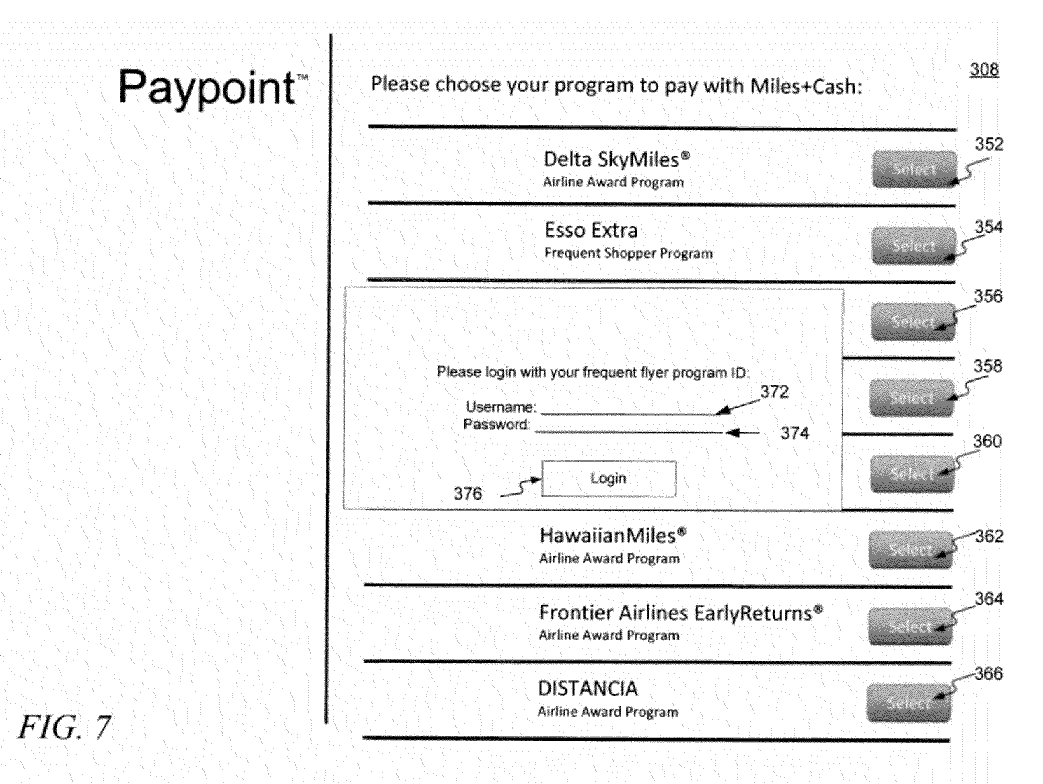

Following selection of a first loyalty program, the user is presented with exemplary graphical user interface 308, as shown in FIG. 7, in which the user is prompted to enter a username 372 and password 374 into respective data fields presented by the currency module in graphical user interface 308. Following entry of a username and password into the respective data fields of graphical user interface 308, the user 105 may initiate processing of the data entered by engaging the login process button 376 which initiates processing of the username and password. The graphical user interface 308, presented on the mobile communication device following a user 105 selecting the currency module on the mobile communication device also includes a process whereby a user 105 that does not know their respective password may have the password sent to the mobile communication device 318.

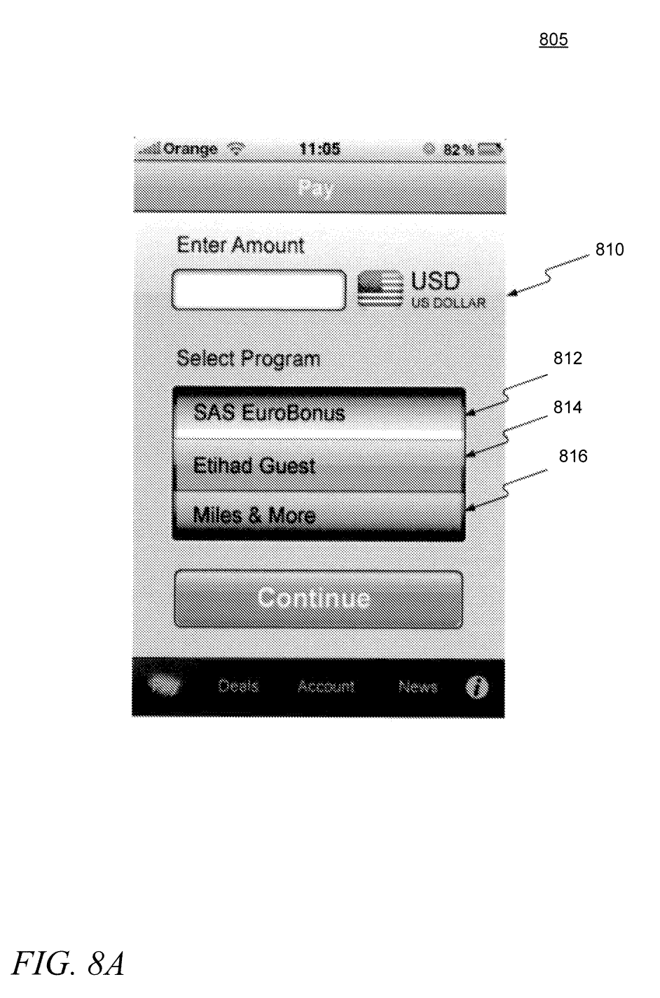

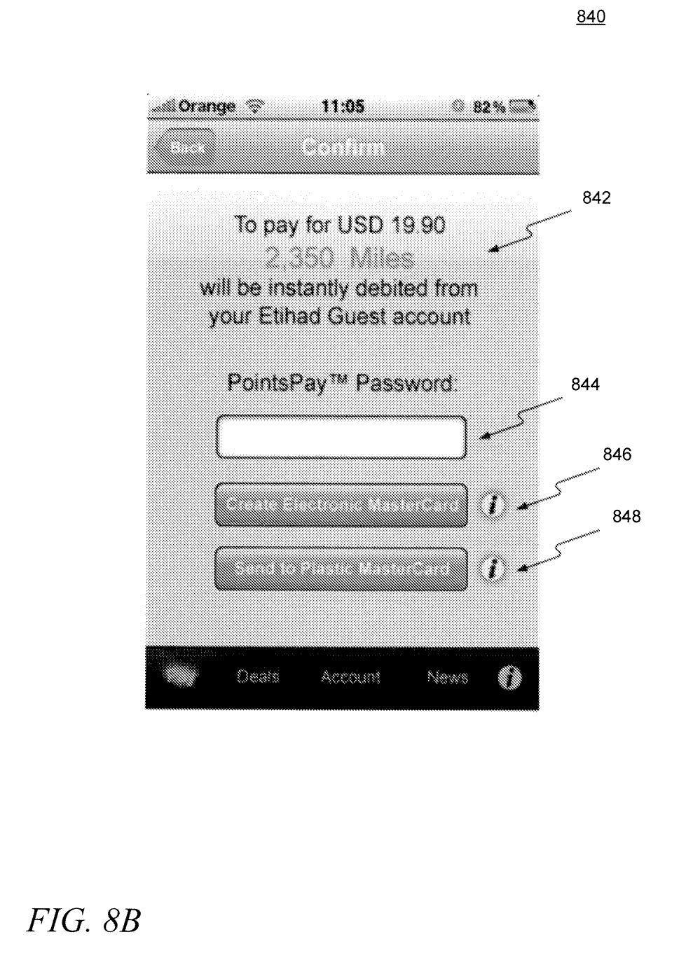

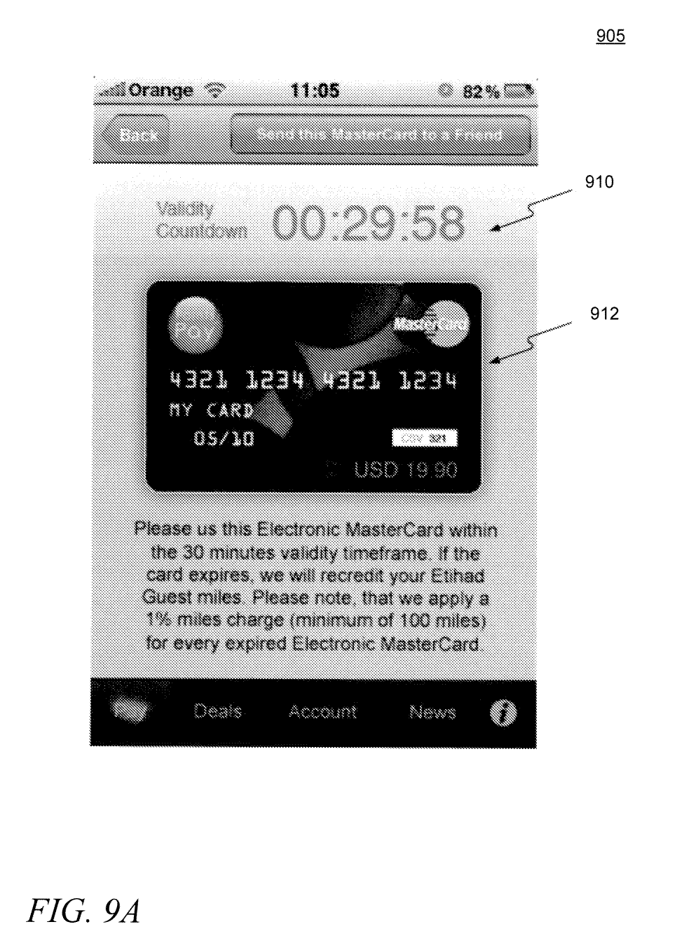

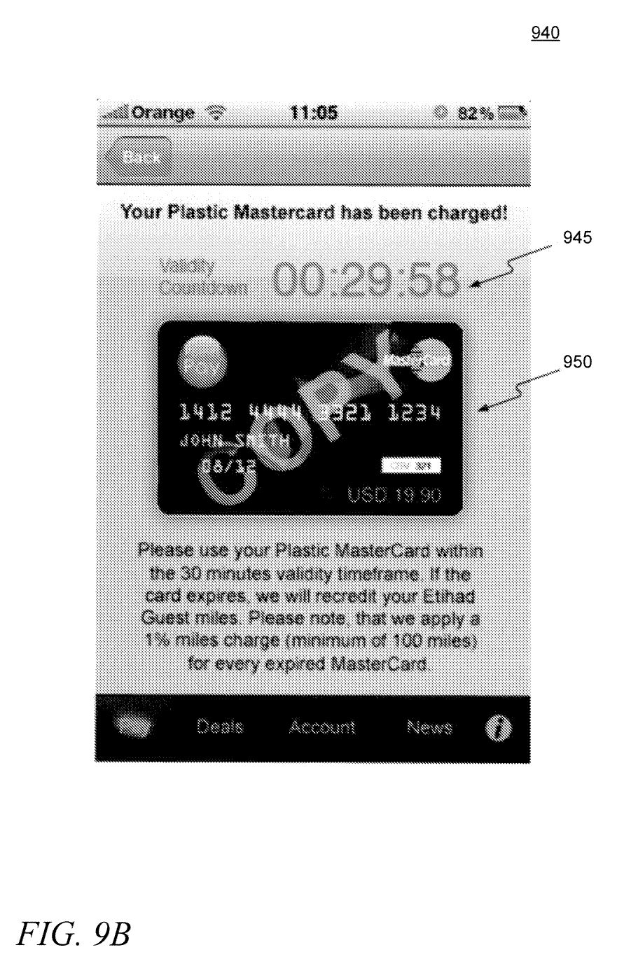

FIGS. 8A, 8B, 9A, and 9B illustrate an alternate embodiment of the invention with an alternate graphical user interface. Turning to FIG. 8A, exemplary graphical user interface 805 is shown as a graphical user interface that can be displayed on a mobile communication device 110. In graphical user interface 805, a user may enter a payment amount and select a currency in field 810. The user may also select from one of the user's loyalty programs as displayed in fields 812, 814 and 816. Once the currency server software module converts the payment amount the user entered into an amount of loyalty points, the loyalty points can be displayed on the mobile communication device 110 as shown in field 842 of graphical user interface 840 in FIG. 8B. Exemplary graphical user interface 840 also shows a field in which the user can enter a password. in order to proceed with the transaction and redeem the points for a credit. The embodiment of graphical user interface 840 also shows that the user has the option of selecting either a credit received at the mobile communications device or a credit applied to a credit card as shown in fields 846 and 848.

Once the currency server software module has redeemed the loyalty points and received a credit from the payment provider server, one of two different displays may be shown on the mobile communications device 110. Referencing FIG. 9A, exemplary graphical user interface 905 is shown displaying a credit issued to the mobile communication device 110. The credit shown in graphical user interface 905 includes a display of a credit card 912 with an account number and a monetary amount resulting from the loyalty points that were redeemed. Associated with the credit is a predefined period of time during which the credit will be available for use as shown in field 910. In alternate embodiments of the invention different time periods can be defined for different credits and in some instances a time period may not be associated with the credit.

As an alternative to a credit delivered to the mobile communications device, the user may receive a credit applied to a credit card or debit card as shown in FIG. 9B. As explained in the exemplary graphical user interface 940 shown in FIG. 9B, in this example a credit has been applied to a plastic credit card within the user's possession. An image of the card 950 is displayed on the mobile communication device and the card contains identifying information including an account number, a name and an amount of monetary currency redeemed for loyalty points. As with the example shown in FIG. 9A, a defined time period during which the credit may be used is also illustrated in field 945.

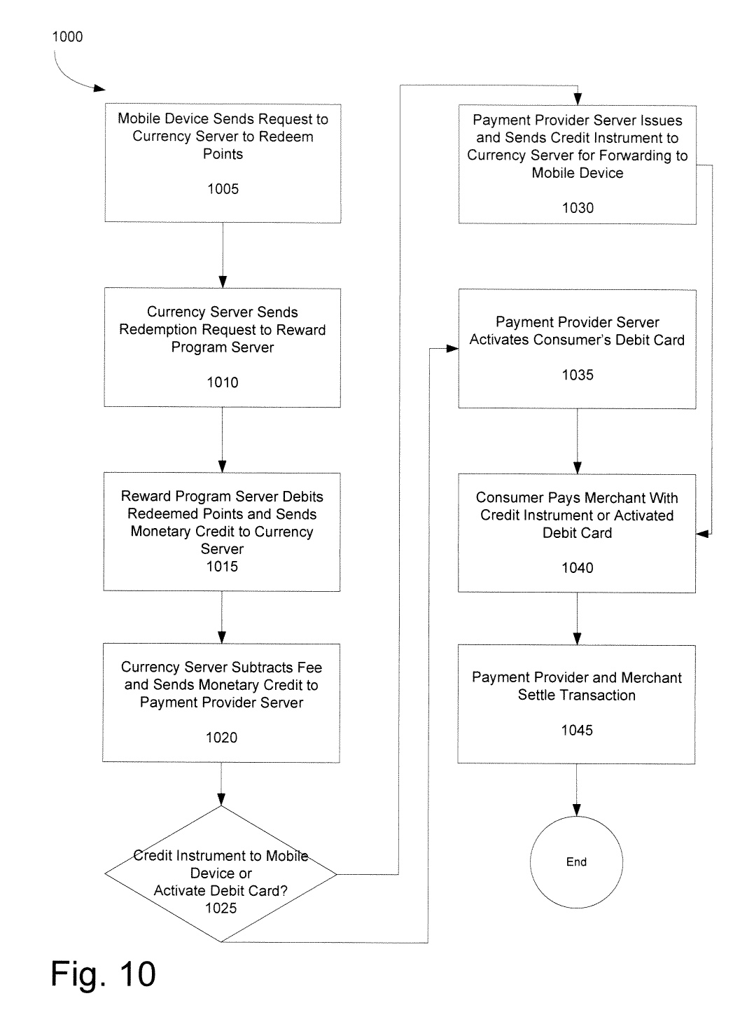

Turning to FIG. 10, a process 1000 is shown explaining in greater detail the movement of loyalty points and monetary currency in accordance with an exemplary embodiment of the invention. Exemplary process 1000 begins at step 1005 with the mobile communication device 110 sending a request to a currency server 120 to redeem an amount of loyalty points. Exemplary process 1000 assumes that prior to step 1005, the user has already submitted a proposed payment amount to the currency server and received an amount of loyalty points required based on a conversion rate associated with the loyalty account. These steps preceding step 1005 were described in greater detail in connection with FIGS. 2A and 2B and throughout the foregoing description.

Referring to step 1010, the currency server 120 sends a redemption request with the previously identified amount of loyalty points to reward program server 140. The reward program server 140 debits the amount of redeemed points from the user's loyalty account and sends a monetary credit to the currency server 120 in step 1015. It will be understood that any one of the reward servers illustrated within reward server 140, including an airline server 142, a hotel server 144, a credit card server 146, or a server associated with another loyalty program may debit the loyalty points and issue the credit to the currency server 120.

In step 1020, the currency server subtracts a transaction fee from the credit received from the reward server 140 and requests a credit from the payment provider server 130 for the remaining balance of the credit. The type of credit the payment provider server 130 issues may depend upon a selection from the user or may be predetermined by the merchant or predetermined by other factors. If a credit to the mobile communications device is selected in step 1025, the payment provider server 130 issues a credit to the currency server 120 for forwarding to the mobile communication device 110. Associated with the credit may be other data including an identifying number for the mobile communication device 110 and a limited time period during which the credit may be used.

Alternatively, if the choice in step 1025 is to receive a credit associated with a physical card in the user's possession, in step 1035, the payment provider server 130 issues a credit to an account, such as an account associated with a debit card in the user's possession. In step 1040, the user can pay the merchant at the point of sale device using either the credit stored on the mobile communication device 110 or the credit applied to an account associated with a physical card, such as debit card. After the user completes the purchase, the merchant settles the transaction with the payment provider operating the payment provider server 130.

Those of skill in the art will recognize that process 1000 is merely an example and that in other embodiments of the invention, the steps in process 1000 may be altered. For example, in another embodiment of the invention, the transaction illustrated in process 1000 can be broken into two separate processes. In such an embodiment, the user may reserve the points to be redeemed with the loyalty server, however, the points may not actually be redeemed until the user makes the purchase. For example, the user could reserve the points to be redeemed while shopping in a store, but the redemption of the points would not actually occur until the user pays for the items purchased at the point of sale.

As additional general information, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general-purpose computer or in any other circuits or systems.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for generating monetary currency comprising:
a currency server software module receiving a payment amount for a transaction and a loyalty program identifier from a mobile communication device;
the currency server software module converting the payment amount to a loyalty points amount based on a conversion rate associated with the loyalty program identifier;
the currency server software module transmitting the loyalty points amount to the mobile communication device and receiving a confirmation for the transaction from the mobile communications device;
the currency server software module transmitting instructions to a loyalty program server to delete the loyalty points amount from a loyalty account associated with the loyalty program identifier; and
the currency server software module transmitting a request to a payment provider server for a credit to be applied for the payment amount.

2. The method of claim 1, further comprising the step of the currency server software module requesting and receiving a verification from the loyalty program server that the loyalty points amount is present in the loyalty account associated with the loyalty program identifier.

3. The method of claim 1, wherein the loyalty program identifier comprises a name of a loyalty program and a loyalty program account number.

4. The method of claim 1, wherein the currency server software module receives a monetary redemption amount from the loyalty program server.

5. The method of claim 4, wherein the currency server software module subtracts a fee from the monetary redemption amount yielding a conversion amount.

6. The method of claim 1, wherein the credit is a credit instrument the currency server software module transmits to the mobile communications device.

7. The method of claim 1, wherein the payment provider server applies the credit to one of a credit account associated with a credit card and a debit account associated with a debit card.

8. A computer-readable storage device comprising computer-readable instructions executed on a computing device, the computer-readable instructions comprising:
first instructions for a currency server software module to receive a payment amount for a transaction and a loyalty program identifier from a mobile communication device;
second instructions for the currency server software module to convert the payment amount to a loyalty points amount based on a conversion rate associated with the loyalty program identifier;
third instructions for the currency server software module to transmit the loyalty points amount to the mobile communication device and to receive a confirmation for the transaction from the mobile communications device;
fourth instructions for the currency server software module to transmit instructions to a loyalty program server to delete the loyalty points amount from a loyalty account associated with the loyalty program identifier; and
fifth instructions for the currency server software module to transmit a request to a payment provider server for a credit to be applied for the payment amount.

9. The computer-readable storage device of claim 8, further comprising:
sixth instructions for the currency server software module to request and receive a verification from the loyalty program server that the loyalty points amount is present in the loyalty account associated with the loyalty program identifier.

10. The computer-readable storage device of claim 8, wherein the loyalty program identifier comprises a name of a loyalty program and a loyalty program account number.

11. The computer-readable storage device of claim 8, further comprising:
seventh instructions for the currency server software module to receive a monetary redemption amount from the loyalty program server.

12. The computer-readable storage device of claim 8, further comprising:
eighth instructions for the currency server software module to receive a credit instrument from the payment provider server and to transmit the credit instrument to the mobile communications device.

13. The computer-readable storage device of claim 8, further comprising:
ninth instructions for the currency server software module to transmit a notice of a credit received from the payment provider server to the mobile communications device, wherein the notice of credit identifies one of a credit account and a debit account.

14. A system for generating monetary currency from loyalty currency comprising:
a currency server, the currency server configured to receive a payment amount for a transaction and a loyalty program identifier from a mobile communications device;
a currency server database coupled to the currency server, the currency server database configured to comprise a conversion rate associated with the loyalty program identifier, the currency server configured to use the conversion rate for converting the payment amount to a loyalty points amount for transmitting to the mobile communications device;
the currency server, configured to receive a confirmation for the transaction from the mobile communication device, and in response, to transmit instructions to a loyalty program server to delete the loyalty points amount from a loyalty account associated with the loyalty program identifier; and
the currency server configured to transmit a request to a payment provider server for a credit to be applied to the payment amount for the transaction.

15. The system of claim 14, wherein the currency server is configured to request and receive a verification from the loyalty program server that the loyalty points amount is present in the loyalty account associated with the loyalty program identifier.

16. The system of claim 14, wherein the loyalty program identifier comprises a name of a loyalty program and a loyalty program account number.

17. The system of claim 14, wherein the currency server is configured to receive a monetary redemption amount from the loyalty program server.

18. The system of claim 17, wherein the currency server is configured to subtract a fee from the monetary redemption amount yielding a conversion amount.

19. The system of claim 14, wherein the credit is a credit instrument the currency server is configured to transmit to the mobile communication device.

20. The system of claim 14, wherein the payment provider server is configured to apply the credit to one of a credit account associated with a credit card and a debit account associated with a debit card.
